(19) United States
(12) Patent Application Publication
(10) Pub. No.: US 2012/0021386 A1
(43) Pub. Date: Jan. 26, 2012

(54) METHOD AND APPARATUS FOR PROVIDING INFORMATION ABOUT A VEHICLE

(75) Inventors: John Richard Anderson, Hampshire (GB); Ashley Dudley, Hampshire (GB); Stephen Perham, Surrey (GB)

(73) Assignee: AIRMAX GROUP PLC, Verwood, Dorset (GB)

(21) Appl. No.: 12/671,687

(22) PCT Filed: Jul. 29, 2008
(86) PCT No.: PCT/GB2008/002566

§ 371 Date: Sep. 9, 2011

(30) Foreign Application Priority Data
Aug. 1, 2007 (GB) 0714936.2

(51) Int. Cl. G09B 9/04

(52) U.S. Cl. 434/66

(57) ABSTRACT

Embodiments of this invention relate to a method and apparatus for providing information about a vehicle for training a driver. Vehicle data is received from a vehicle data gathering mechanism (104) associated with a vehicle (100). Image data from an image data gathering mechanism (102) associated with the vehicle is then received. The image data is then overlaid with cotemporaneous vehicle data. The image data is then stored with the overlaid vehicle data in computer memory (108). Other embodiments are disclosed in this application.

### CROSS-REFERENCE TO RELATED APPLICATIONS

This application claims the benefit of PCT No. PCT/GB2008/002566, filed Jul. 29, 2008, which claims the benefit of United Kingdom Patent Application No. 0714936.2, filed Aug. 1, 2007. PCT No. PCT/GB2008/002566 and United Kingdom Patent Application No. 0714936.2 are incorporated herein by reference.

### FIELD OF THE INVENTION

This invention relates to a method and apparatus for providing information about a vehicle. In particular, but not exclusively, the invention relates to a method and apparatus for providing information that can be used for training a driver comprising overlaying image data with cotemporaneous vehicle data such that the combined data can be analysed.

### BACKGROUND

It is known to install a video camera into a vehicle in order to obtain information about the driving of a vehicle in the form of video footage. The video footage can be used to counsel drivers on how to correct bad driving habits, such as tailgating or not paying attention. The videos can also be used to determine liability when an accident occurs, in order that drivers can be exonerated and claims can be settled quickly.

### SUMMARY OF EMBODIMENTS OF THE INVENTION

According to a first aspect of embodiments of the invention, there is provided a method for training a driver comprising the steps:
receiving vehicle data from a vehicle data gathering mechanism associated with a vehicle;
receiving image data from an image data gathering mechanism associated with the vehicle;
overlaying the image data with cotemporaneous vehicle data; and
storing the image data with the overlaid vehicle data in computer memory.

Storing the image data with the overlaid vehicle data in computer memory may comprise storing the combination of the vehicle data and the image data as a single entity such that the vehicle data cannot be easily separated from the image data. This can keep the computer memory required to store the data to a minimum.

In other embodiments, the image data and the vehicle data may be stored in computer memory as separate entities, and a link between the two sets of data may be provided such that the vehicle data is overlaid onto the image data when it is retrieved from memory: the two sets of data may be combined as and when the data is downloaded, or otherwise retrieved from computer memory. In these embodiments of the invention it may be easier for a user to control where on the image data the vehicle data is displayed, and in some embodiments whether or not the vehicle data is displayed at all.

The stored image data with the overlaid vehicle data can be used to determine how well the driver is driving, and subsequently to train the driver, preferably by providing feedback to the driver. Feedback can be provided to the driver in the form of replaying the image data with the overlaid vehicle data to the driver, preferably replaying portions of the image data that correspond to one or more incidents. The feedback may be provided by feedback mechanism, for example a visual display. The visual display may be a computer monitor, a television screen, a display on a mobile telephone, a laptop computer, or any other mechanism.

In some embodiments, the feedback may comprise a report, preferably a statistical report, that provides analysis of the driver. The report may be printed on paper, or it may be viewable on a visual display unit. In some embodiments, the feedback may be a comparison between the driver's old performance and the current performance. This can enable a driver's progress and learning to be seen. The comparison between a drivers previous performance and current performance can enable the driver's insurance premiums to be increased or decreased depending on whether the driver's performance has increased or decreased.

The combination of data can provide a high level of detail as to how well the driver is driving, including how safely the driver is driving. Knowing the values of parameters associated with the vehicle data that is cotemporaneous with the displayed image data can enable a more accurate determination of the quality of a driver to be determined, and hence more accurate training to be provided. Some embodiments of the invention may be considered as methods and apparatus for improving the safety of a driver.

The determination of how well the driver has driven may be made automatically, for example by a computer program processing the data, and any feedback may also be provided to the driver automatically. Alternatively, or additionally, the determination of how well the driver was driving may be made by a human operator watching the image data with the overlaid vehicle data, and the human operator may provide any feedback to the driver personally, or may generate a report that is issued to the driver.

The vehicle data may be information that is derived from the vehicle, preferably from the engine of the vehicle. The vehicle data may comprise any one, or more, of parameters associated with revolutions per minute (rpm); speed; distance; acceleration; deceleration; fuel consumption/usage; miles per gallon (mpg); throttle position; gear ratio; idle ratio; any faults associated with the vehicle, tachometer data, fuel consumption data, electrical fault data.

In some embodiments, further parameters that can be obtained from the vehicle data gathering mechanism can include: steering wheel position, pedal positions, hand brake position, whether or not the windscreen wipers are on, use of the indicators, use of headlights, etc.

The computer memory may be located on the vehicle, or it may be located off the vehicle, or it may be split between an on-vehicle memory and an off-vehicle memory. One or more transceivers located on the vehicle, and at an off-vehicle location may be used to provide a wireless communication channel between an on-vehicle computer memory and an off-vehicle computer memory. There may be duplication of the data that is stored in an on-vehicle memory and an off-vehicle memory. An advantage to storing the data in a computer memory on-vehicle is that data need only be retrieved from the vehicle when it is required, and that data is not transmitted from the vehicle unnecessarily if there is no interest in the stored data at the location of the off-vehicle memory. This can reduce the amount of bandwidth required for transmitting data from the vehicle

The method may further comprise comparing one, or both, of the image data and vehicle data with a rule to determine if an incident has occurred. Comparing one, or both, of the image data and vehicle data may be performed automatically using a computer. The method may further comprise retrieving the image data with the overlaid vehicle data upon the determination of an incident. Details of events surrounding the incident can be used to train the driver in some embodiments.

In other embodiments, the invention can be considered as a driving incident capturing system, which may include a fault assessment system. Embodiments of the invention can also be used to improve the safety of a driver. In particular, the circumstances surrounding an incident may be used to assess how safely a driver drives. Feedback in relation to the safety of a driver can then be provided either directly to a driver, or to an appropriate third party.

As a non-exhaustive list of examples, an incident may comprise: an accident, a crash, a poorly executed driving manoeuvre, the activation of a warning light on the dashboard, the trigger of a diagnostic trouble code (DTC), an unexpected change in a vehicle parameter, for example the engine cutting-out while the vehicle is moving, a driver indicated incident, etc.

The circumstances surrounding an incident may be of particular interest when training a driver, such that the driver can improve any poor driving that led to the incident. Identification of an incident in itself may be capable of being used to provide feedback to the driver. For example, an incident that illustrates heavy breaking by a driver may indicate that the driver has left an insufficient stopping distance, and appropriate training may be provided.

Knowledge of an incident can enable embodiments of the invention to be used as a safety system, preferably capable of reporting bad drivers. Embodiments of the invention may be used for crime prevention, and may be considered as a security system. For example, if another driver performs a bad manoeuvre, such as cutting across in front of me and causing me to brake harshly, I can email the video footage directly to the police. Another example of bad driving that may be reported is if another driver is illegally driving in a bus lane. In some embodiments, the footage may be sent directly to the police automatically, without human intervention, by any suitable mechanism.

In other embodiments, an incident may be a positive/good event, for example a well executed driving manoeuvre, and the driver training associated with the occurrence of a positive incident may comprise complementing a driver, and possibly rewarding the driver.

The method may further comprise transmitting the image data with the overlaid vehicle data from an on-vehicle memory to an off-vehicle location, preferably, transmitting the retrieved data associated with an incident. Occurrence of an incident may trigger the method to transmit the image data with the overlaid vehicle data from the on-vehicle memory to an off-vehicle location, other examples of triggers may include, a driver initiated trigger, a third party sending an interrogation signal to the vehicle, the expiry of a predefined period of time since the last transmission of data, etc.

The method may further comprise receiving vehicle location data from a vehicle location data gathering mechanism; and overlaying the image data with cotemporaneous vehicle location data. The vehicle location data may provide even further detail of the driving habits and qualities of a driver, so as to improve the driver training. Where the vehicle is driven may influence whether or not certain parameters of the vehicle data are deemed acceptable. For example, if different speed limits are in force in different geographical locations, for example in different states or in different countries, the value of a speed parameter from the vehicle data may be considered differently. The vehicle location data may also be useful to an employer/manager of the driver as an indicator of where the driver has driven, so that the training can be tailored accordingly.

The method may further comprise receiving trip data from a trip data gathering mechanism; and overlaying the image data with cotemporaneous trip data. The trip data may provide information about an individual journey. A non-exclusive list of examples of parameters associated with the trip data may include one, some, or all, of: the current date, the current time, the trip start time, the trip duration, the distance traveled on the trip, the identity of the driver for the trip, an odometer reading at the start of the trip, a fuel level in the vehicle at the start of the trip, and fuel used during the trip.

Again, the trip data may provide even further detail of the driving habits and qualities of a driver, so as to improve the driver training. For example, if a driver is driving excessively long trips/journeys, they may require training to reduce the length of their trips, or training to take longer breaks during and/or between trips. Additionally, or alternatively, training may be required if a driver regularly runs their vehicle until the fuel tank is nearly empty.

The vehicle data may be received from an engine management system within the vehicle. The vehicle data may be received from an On Board Diagnostics (OBD) connector within the vehicle. The vehicle data may be received from a Controller Area Network (CAN) bus within the vehicle. Retrieving the vehicle data from a system that is already present in the vehicle can reduce the amount of equipment that needs to be fitted to a vehicle in order to work embodiments of the invention. Existing systems may be able to provide the vehicle data that is required for embodiments of the invention.

The method may further comprise deleting, or overwriting/replacing, existing image data with overlaid data in computer memory and storing new image data with overlaid data to memory which previously held earlier existing image data with overlaid vehicle data. Preferably the computer memory is a first-in-first-out memory, in order to make efficient use of the computer memory.

Portions of the existing image data with overlaid vehicle data in computer memory may be identified as not to be deleted from computer memory. The portions of the existing image data with overlaid data in computer memory that are identified as not to be deleted from computer memory may be associated with an incident. Identifying data such that it is not to be deleted can ensure that any important data is not deleted from memory when it becomes the oldest data in memory. Data that is not to be deleted may be so identified automatically by computer software when an incident occurs. Alternatively, a user of the system, for example the driver or a remote user such as a manager or a person representing an insurance company, may identify certain portions of memory that are not to be deleted.

According to a second aspect of embodiments of the present invention, there is provided apparatus for training a driver comprising:
vehicle data gathering mechanism arranged to provide vehicle data associated with a vehicle;
image data gathering mechanism arranged to provide image data associated with the vehicle;
a computer processor arranged to overlay the image data with cotemporaneous vehicle data; and
a computer memory arranged to store the image data with the overlaid vehicle data.

The feedback mechanism may be arranged to provide feedback to the driver. The feedback mechanism may comprise a visual display arranged to replay the image data with the overlaid vehicle data to the driver.

The computer processor and the computer memory may be located on the vehicle.

The computer processor may be arranged to compare one, or both, of the image data and vehicle data with a rule to determine if an incident has occurred. In other embodiments, the image data and vehicle data may be transmitted/streamed off the vehicle substantially in real time, and any further processing of the data, including comparing the data with a rule to determine if an incident has occurred, may be performed by an off-vehicle processor.

The computer processor may be arranged to retrieve the image data with the overlaid vehicle data upon the determination of an incident.

The apparatus may further comprise a transmitter arranged to transmit the retrieved image data with the overlaid vehicle data from an on-vehicle memory to an off-vehicle location.

The apparatus may further comprise vehicle location data gathering mechanism arrange to provide vehicle location data associated with the vehicle, and the computer processor may be further arranged to overlay the image data with cotemporaneous vehicle location data.

The apparatus may further comprise trip data gathering mechanism arrange to provide trip data associated with the vehicle, and the computer processor may be further arranged to overlay the image data with cotemporaneous trip data.

The vehicle data gathering mechanism may be arranged to receive the vehicle data from an engine management system within the vehicle.

The vehicle data gathering mechanism may be arranged to receive vehicle data from an On Board Diagnostics (OBD) connector within the vehicle.

The vehicle data gathering mechanism may be arranged to receive vehicle data from a Controller Area Network (CAN) bus within the vehicle.

The computer processor may be further arranged to delete or overwrite/replace existing image data with overlaid data from computer memory and store new image data with overlaid vehicle data to memory which previously held earlier existing image data.

The computer processor may be arranged to identify portions of the existing image data with overlaid data in computer memory as not to be deleted from computer memory.

The computer processor may be arranged to identify portions of the existing image data with overlaid data in computer memory that are associated with an incident as not to be deleted from computer memory.

According to a further aspect of embodiments of the invention, there is provided a driving incident capturing system comprising:
vehicle data gathering mechanism arranged to provide vehicle data associated with a vehicle;
image data gathering mechanism arranged to provide image data associated with the vehicle;
a computer processor arranged to overlay the image data with cotemporaneous vehicle data; and
a computer memory arranged to store the image data with the overlaid vehicle data.

The image data gathering mechanism may be arranged to provide images from more than one view from the vehicle, and the computer processor may be arranged to superpose the images from the more than one view from the vehicle with vehicle data and store the superposed data in computer memory, preferably as a single entity/combined electronic file in computer memory.

Embodiments of the invention may be considered as an environment information and vehicle data acquisition system. The system may be used to acquire data in relation to driving offences, crime, and/or incidents. The system may be a crime detection/recording system.

In some embodiments, the invention may be used to set insurance premiums. An insurance company may be able to monitor the driving of individual drivers, or groups of drivers, and set insurance premiums based upon the gathered information, and preferably based upon any feedback that is provided in relation to the driving. The insurance company may be able to receive information remotely from the vehicle, for example via a wireless connection, or alternatively, the insurance company may be able to plug-in to a computer memory that contains the required information. In other embodiments, the information may be stored on a removable memory device, for example a memory stick, and the removable memory device can be posted to the insurance company.

Some embodiments of the present invention may be considered as a temporary store for information relating to a vehicle, preferably a temporary store for any of the types of information discussed in this patent application. Information within the temporary store may be automatically overwritten automatically after a predetermined period of time, for example 1 hour, 2 hours, 12 hours, 1 day, 2 days, 1 week, a fortnight, a month, or any other period of time. In other embodiments, information within the temporary store may be overwritten when the store is full, and the temporary store may be a first-in-first-out store.

The temporary store may be located on a vehicle, and information in the temporary store may be sent off the vehicle. Information may be sent off-vehicle when a driver triggers an event/incident, when computer software triggers an event, or when a remote manager/interrogator calls for a record of the information. In some embodiments, an event may cause the information to be stored more permanently, and/or for the information to be sent off-vehicle as discussed above.

According to a further aspect of embodiments of the invention, there is provided a method of calculating an insurance premium comprising:
receiving vehicle data from a vehicle data gathering mechanism associated with a vehicle;
receiving image data from an image data gathering mechanism associated with the vehicle;
overlaying the image data with cotemporaneous vehicle data;
storing the image data with the overlaid vehicle data in computer memory; and
analysing the stored data so as to influence the insurance premium.

According to a further aspect of embodiments of the present invention, there is provided apparatus for calculating an insurance premium comprising:
vehicle data gathering mechanism arranged to provide vehicle data associated with a vehicle;
image data gathering mechanism arranged to provide image data associated with the vehicle;
a computer processor arranged to overlay the image data with cotemporaneous vehicle data; and
a computer memory arranged to store the image data with the overlaid vehicle data,
wherein the computer processor is arranged to calculate an insurance premium based upon an analysis of the stored image data with the overlaid vehicle data.

According to a further aspect of embodiments of the invention, there is provided a method of determining the liability for an insurance claim comprising:
receiving vehicle data from a vehicle data gathering mechanism associated with a vehicle;
receiving image data from an image data gathering mechanism associated with the vehicle;
overlaying the image data with cotemporaneous vehicle data;
storing the image data with the overlaid vehicle data in computer memory; and
analysing the stored data so as to determine the liability for an insurance claim.

The analysis of the stored data may be performed automatically, or may be performed by a human operator/user.

According to a further aspect of embodiments of the present invention, there is provided apparatus for determining the liability for an insurance claim comprising:
vehicle data gathering mechanism arranged to provide vehicle data associated with a vehicle;
image data gathering mechanism arranged to provide image data associated with the vehicle;
a computer processor arranged to overlay the image data with cotemporaneous vehicle data; and
a computer memory arranged to store the image data with the overlaid vehicle data,
wherein the computer processor is arranged to determine the liability based upon an analysis of the stored image data with the overlaid vehicle data.

It will be appreciated that any of the optional features of any of the aspects of embodiments of the invention could also be optional features of any of the other aspects of embodiments of the invention.

### BRIEF DESCRIPTION OF THE DRAWINGS

Embodiments of the invention will now be described in detail, by way of example only, and with reference to the accompanying drawings, of which:—

FIG. 1 shows schematically a system for providing information according to an embodiment of the present invention;

FIG. 2 shows schematically a still image from video footage having vehicle data overlaid on the video footage according to an embodiment of the present invention;

FIG. 3 shows schematically the inside of a vehicle fitted with a system for training a driver according to an embodiment of the present invention;

FIG. 4 shows schematically a system for training a driver according to another embodiment of the present invention;

FIGS. 5a and 5b show still images of overlaid video footage according to an embodiment of the present invention;

FIG. 6 shows a flow chart showing the steps performed according to embodiments of a method of the present invention for recording captured images with overlaid vehicle data to memory;

FIG. 7 shows a flow chart showing the steps performed according to embodiments of a method of the present invention for recording data to memory;

FIG. 8 shows a flow chart showing the steps performed according to embodiments of a method of the present invention for transmitting extracted data from computer memory;

FIG. 9 shows a flow chart showing the steps performed according to embodiments of a method of the present invention for retrieving stored data from memory when an incident occurs; and

FIG. 10 shows an image data gathering mechanism according to an embodiment of the present invention.

### DETAILED DESCRIPTION OF EXAMPLES OF EMBODIMENTS

The present invention, in one embodiment, relates to a method and system for training a driver of a vehicle. In particular, embodiments of the present invention can be used to provide information that can be analysed to determine how well a driver drives in order to train the driver accordingly. In some embodiments the circumstances surrounding an incident that has occurred in or near a vehicle may be analysed, and the incident may be an accident, which may, or may not, lead to an insurance claim and/or a criminal prosecution by the police.

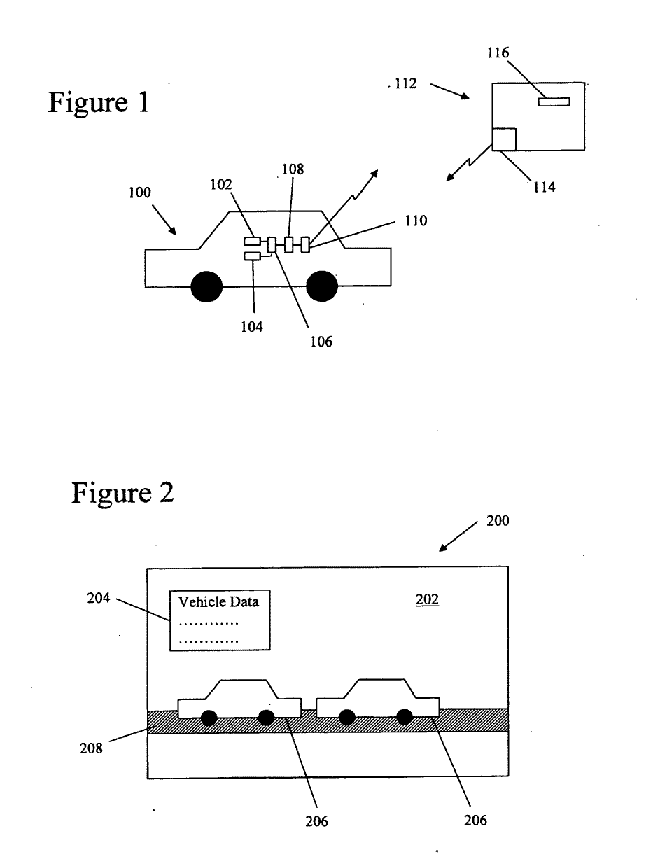

FIG. 1 shows a system according to an embodiment of the present invention. A car 100 is fitted with an image recording mechanism 102, a vehicle data gathering mechanism 104, computer processor 106, computer memory 108, and a transceiver 110 capable of emitting wireless signals.

The image recording mechanism 102 and the vehicle data gathering mechanism 104 are both connected to the computer processor 106, which is arranged to overlay or superpose the gathered vehicle data on top of the recorded image data such that the overlaid vehicle data is cotemporaneous with the image data on which it is overlaid: that is to say images and vehicle data from the same points in time are overlaid. The combined vehicle data and image data are stored in computer memory 108 until such a time that it is determined that the data should be transmitted by the transceiver 110 to an off-vehicle location. In other embodiments, the combined data may be transmitted off-vehicle substantially in real-time, that is, as it is recorded, and in other embodiments the combined data may not be wirelessly transmitted off the vehicle at all.

In some embodiments, the vehicle data and image data may be retrieved from a computer memory 108 within the vehicle by plugging a data retrieval device into a port in the vehicle to access computer memory 108. In such embodiments, a wireless transceiver 110 may not be required in the vehicle 100, as the required data may be retrieved from computer memory 108 by any form of direct or indirect wired connection.

In embodiments of the present invention, the processing that is performed by computer processor 106 in order to combine the vehicle data and image data can be partly, or entirely, performed by an off-vehicle computer processor. Likewise, in some embodiments an off-vehicle computer memory may be used instead of, or in addition to, the on-vehicle computer memory 108.

In some embodiments, the on-vehicle apparatus of the invention may consist of only the vehicle data gathering mechanism 104, the image recording mechanism 102 and the transceiver 110. In such an embodiment, the recorded data can be transmitted off-vehicle substantially in real-time, and no, or very little, computer processing or data storage may be performed on-vehicle.

It will be appreciated that the physical location of the one or more computer processors, and the one or more computer memories, is not important (in some embodiments) as long as the vehicle data and image data are combined such that the time at which the vehicle data was recorded coincides with the time at which the image data was recorded. In other embodiments it is important that the merged/superposed images and vehicle data record is created and stored, at least temporarily, on the vehicle.

The combined vehicle data and image data can then be used to determine how well a driver was driving, and therefore can be used in an effort to improve the quality of the driver in areas where they were unsatisfactory. In particular, the quality of driving leading up to, during and/or after an incident can be considered, as discussed in more detail later, as can any ameliorating circumstances derivable from the video footage, for example.

A driving instructor, manager/employer of the driver, or any other qualified person, may watch the combined image and vehicle data to perform an analysis of the quality of the driving. In alternative embodiments, the driving quality analysis may be performed automatically by a computer program/algorithm, which monitors parameters of the vehicle data and/or image data. The computer program/algorithm may have at least some image processing capability in order to identify certain events from the image data. For example, image processing software may be programmed to recognise lane markings and therefore lane changing manoeuvres. The software may be able to determine how close a vehicle is to an adjacent vehicle, and possibly be capable of determining how quickly one vehicle is approaching another vehicle. In other embodiments, the image processing software may be able to recognise road signs, speed limit signs, etc.

Embodiments of the invention may be particularly useful for monitoring the driving habits and qualities of individuals who are considered as high risk, for example young drivers, people with poor driving history, etc. Embodiments of the invention may be used to more fairly reward and penalise drivers based upon how they actually drive, as opposed to based on a statistical analysis of their age, gender, type of car they own, etc. Embodiments of the invention may be used more fairly to determine insurance premiums for a driver who is driving well, as determined from the image data overlaid with vehicle data, whereby the same driver may have been unfairly penalised because of their age (for example) without taking into account the quality of the driver as determined by embodiments of the present invention. A driver who generates few incidents may be rewarded/not penalised.

In some embodiments, the present invention may be used to determine the quality of driving of a driver who is involved in an accident, and also to determine who was responsible for the accident. This information may be useful when a driver makes a claim under their driving insurance policy, so that the correct liability for the claim can be determined, and the correct insurance policy can be claimed under.

Embodiments of the invention can be considered as an evidence gatherer/storer in order to provide proof of events related to an accident or bad driving. The evidence can be used for training the driver who performed the bad driving or was involved in an accident, or for setting insurance premiums for drivers who performed the bad driving or who were involved in an accident. In some embodiments, the evidence can be used for assessing circumstances surrounding an accident, settling insurance disputes in relation to an accident, determine liability for the accident, and/or for use in criminal proceedings.

In some embodiments, the invention provides a temporary reservoir of recent past history of events that have occurred in or near a vehicle. Recent past history may comprise the last weeks events, the last fortnights events, the last months events, or any other suitable period of time that can be stored in computer memory.

The image recording mechanism 102 may be a camera, such as a video camera associated with the vehicle, preferably inside the vehicle and near a window of the vehicle, for example facing forwards out of the front windscreen of a vehicle. The video camera may have a sampling rate that is high enough to accurately identify any incident that may occur near the vehicle. In some embodiments, the sampling rate may be 50 Hz. A similar, or the same, sampling rate may be used for recording vehicle data. In other embodiments the sampling rate may be reduced in order to make efficient use of the computer memory 108 within the vehicle 100. Such a sampling rate may be 1, 2, 4, 10, 20, or any other number, of samples per second.

The camera may be a digital video camera, such as a charge-coupled device (CCD) video camera.

In some embodiments, the sampling rate may be variable, for example to make efficient use of the computer memory available. For example, whilst the vehicle is stationary (as determined from the vehicle data or by any other mechanism, for example vehicle location data), the sampling rate may be reduced to a lower value, or may be increasingly reduced over time whilst the vehicle is stationary until no samples are taken after the vehicle has been stationary for a certain amount of time. The sampling rate may be increased when the vehicle starts moving again. This can avoid wasting computer memory (which may be limited), as well as reducing unnecessary computer processing, by not recording data when the vehicle is not being used, for example when it is locked in a garage overnight.

Similarly, the sampling rate of the image recording mechanism 102 may be increased when the car 100 is travelling at high speeds in order to more accurately capture details when events happen faster.

Information that is gathered by the vehicle data gathering mechanism 104 can be used to determine if, when, and how often images should be recorded by the image recording mechanism 102. This may be achieved by altering the sampling rate of the image recording mechanism 102, and/or activating and deactivating the image recording mechanism 102. In some embodiments, sampling may only take place whilst the vehicle's engine is turned on. The processor 106 may use speed data from the vehicle data gathering mechanism 104 to control the image recording mechanism 102.

In some embodiments, the vehicle 100 may comprise more than one image recording mechanism 102. For example, a first image recording mechanism may record images in front of the vehicle 100, and a second image recording mechanism may record images behind the vehicle 100. It will be appreciated that any number of image recording mechanism can be used to capture images on any side of the vehicle. Furthermore, one or more image recording mechanism may be used to record images within the vehicle itself. This may be useful to determine what the driver was doing when an incident occurred. For example, it may be useful to know if they were using a mobile telephone, or changing a CD/altering the audio/music system, or reading a map, or falling asleep, or paying close attention to the road.

In further embodiments still, an image recording mechanism that is already present in the vehicle, for example a video camera that is located near a back bumper of the vehicle in order to aid parking, may also be used to record image data for the present invention.

Instead of/as well as having more than one image recording mechanism 102, the vehicle may have optics to present more than one viewing direction to the same recording mechanism 102, for example an image capturing lens and a fibre optic could capture a rear-view whilst a video camera's normal lens captures a forward view. The two (or more) views could be recorded as a split screen, multiplexed (e.g. alternate frames) or their data superposed in the same frame, or recorded together in some other way.

The vehicle data is information that is derived from a vehicle, preferably from the engine of the vehicle. The vehicle data gathering mechanism 104 may use engine management systems that are already present in the vehicle to obtain the vehicle data. The vehicle data gathering mechanism 104 may obtain vehicle data from a Controller Area Network (CAN) bus within the vehicle, and/or from a European On Board Diagnostics interface (EOBD) port within the vehicle.

A known interface for monitoring the status and performance of a vehicle engine in Europe is the EOBD. There is also an American equivalent on-board diagnostics standard, identified by the abbreviation OBD. Each vehicle manufacturer tailors a number of output ports of the EOBD socket to carry data relating to a number of parameters of vehicle performance. Such data can be derived from sensors throughout the vehicle, for example: speed, distance, tachometer data, fuel consumption data, and electrical fault data. Also, values outside of an acceptable range trigger a diagnostic trouble code (DTC). These DTCs can be used to illuminate warning lamps or displays on the vehicle's dashboard.

Information that may be obtained from the engine management system through the EOBD port can include, but is not limited to: revolutions per minute (rpm); speed; distance; acceleration; deceleration; fuel consumption/usage; miles per gallon (mpg); throttle position; gear ratio; idle ratio; and any faults associated with the vehicle. Data relating to one, some, or all of the above parameters may be gathered by the vehicle data gathering mechanism 104 when it is connected to an EOBD port.

In some embodiments, further parameters that can be obtained from the vehicle gathering mechanism can include: steering wheel position, pedal positions, hand brake position, whether or not the windscreen wipers are on, use of the indicators, use of headlights, etc.

The EOBD/OBD also has a clock so that the time at which signals were generated can be determined.

Providing the vehicle data in combination with the cotemporaneous image data can provide a greater degree of insight into the driving quality/tendencies of a driver when compared with analysing just the vehicle data or image data. Embodiments of the present invention can provide a finer granularity to determine how safe/good the driver is.

In this embodiment, the vehicle data is stored in combination with the image data as a single entity in computer memory—that is, it may not be easy to separate the vehicle data from the image data in computer memory. Storing the combined data as a single entity/file type can use the computer memory efficiently, and particularly can make good use of the available capacity of computer memory. This may allow data relating to a longer period of time to be stored in computer memory before needing to be deleted or backed-up.

In other embodiments, the vehicle data and image data may be stored in computer memory as separate entities/file types. There may be link, for example in a look-up table in computer memory, that provides a correlation between the area of memory in which vehicle data is stored and the area in computer memory that the corresponding image data is stored. Advantages of these embodiments can include that the exact location at which the vehicle data is overlaid on top of the image data can be specified at a later stage after any particularly important areas of the recorded images have been determined. In some embodiments, the image data and vehicle data may be combined when the data is retrieved from computer memory, preferably when it is downloaded from a computer memory located on the vehicle. It may also be easier to compare specific details of the image data and/or vehicle data before they are combined into a single entity.

As discussed above, the vehicle data is overlaid onto the cotemporaneous image data by the computer processor 106 and stored in computer memory 108. In addition, the computer processor 106 may be arranged to compare the vehicle data and/or image data (and/or any other information that has been recorded in relation to the vehicle, for example trip data and vehicle location data as discussed later) with one or more rules to determine if an incident has occurred. An incident may warrant particular attention when analysing a driver's driving. The one or more rules may define threshold values, which if exceeded would be determined as an indication of potentially unsafe driving.

An incident may be identified by monitoring the vehicle data that has been gathered by the vehicle data gathering mechanism and/or monitoring the image data recorded by the image recording mechanism 102 and comparing this data with a rule that defines one or more threshold values. For example, if the deceleration of the vehicle is greater than a threshold value the computer processor 106 may determine that an incident has occurred. In such an example the incident may be a crash, or poor driving caused by a failure to leave an adequate stopping distance to the vehicle in front.

If an airbag is activated, or the vehicles fuel cut-off switch is activated, for example, the data may be captured and used as a trigger for indicating an incident.

In some embodiments, the threshold may be fixed for a certain parameter, and in other embodiments, the value of the threshold which identifies an incident may be variable, and may depend upon the present value of a parameter. For example, the rate of change of the revolutions per minute of the engine may be more or less of a concern when the rpm is already at a high value, that is, it may be more dangerous/unsafe, and less economical, for the engine speed to increase sharply when it is already at a high value. As another example, the maximum rpm threshold that defines an incident may be reduced when it is raining (as determined from a parameter indicating use of the wipers), when it is dark (as determined by use of the headlights), etc.

It will be appreciated that any of the vehicle data parameters discussed in this patent application could be considered/monitored/analysed in order to determine if an incident has occurred.

Embodiments of the invention may have one or more rules that identify/trigger an incident if any of the data exceeds, or falls below, a certain threshold, or is not within a predefined range. Other rules may cause an incident to be triggered if a combination of parameters satisfy certain criteria, for example if the darkness of the image data shows that it is night time, and the speed exceeds a certain value. In some embodiments, night time may be determined by a calendar/clock function, for example a calendar/clock function that is available through the EOBD port. In some embodiments, an incident may be identified if the speed of the vehicle exceeds the maximum national speed limit, which is 70 mph in the UK. Properties of the geographical area where a vehicle is being driven, for example the speed limit that is in force, may be determined from geo-coded information that is available to the system in combination with the location of the vehicle. The location of the vehicle may be determined by any known mechanism.

The rules may be stored in computer memory 108 in the vehicle 100, such that the rules can be applied to the data before transmitting the data from the vehicle. In embodiments where the data is transmitted/streamed from the vehicle substantially in real-time, the rules may be stored in an off-vehicle computer memory. It will be appreciated that the rules may be stored in any computer memory that is conveniently located to reduce/minimise the amount of computer processing/communication channel bandwidth that is required to apply the rules.

In some embodiments, the driver may have the option to identify an incident themselves if they believe that an incident would not otherwise be triggered. This may cause data relating to the incident identified by the driver to be retrieved from memory, and possibly transmitted from the vehicle. Alternatively, the data may be stored in computer memory and marked so that it cannot automatically be overwritten/deleted. For example, the driver may witness an incident in which they are not directly involved, but yet the driver may think that the recorded image and vehicle data may be useful for training, or may be useful in relation to an insurance claim by a third party who is visible in the recorded image data, or useful to the police. The driver may identify the incident themselves by pressing a button within the vehicle, or by any other mechanism. Alternatively, a driver may inform a manager of the system, or their manager, or their employer, or any other suitable person, of the incident, and that person can remotely retrieve information from computer memory. This can enable remote controlled interrogation of on-vehicle computer memory.

Embodiments of the invention can be used to replay an accident or crash, and provide details regarding an alleged motoring offence, for example a speeding offence.

Upon the identification of an incident, or upon receipt of an “interrogate history” signal from a driver or a remote interested party, the combined vehicle and image data may be retrieved from computer memory 108 and transmitted by transceiver 104 to a wireless receiver 114 in an off-vehicle computer 112. The off-vehicle computer comprises a computer processor 116. The combined vehicle and image data may be transmitted over a mobile telephone network, and in some embodiments, the footage may be sent directly to a mobile telephone that has the capability to display the footage. In some embodiments, the off-vehicle processor may inform a third party such as a supervisor/manager that an incident has occurred for example by an email, SMS text message to a mobile phone, or by any other mechanism.

Further examples of an incident may include an accident, a crash, a poorly executed driving manoeuvre, the activation of a warning light on the dashboard, the trigger of a diagnostic trouble code (DTC), an unexpected change in a vehicle parameter, for example the engine cutting-out while the vehicle is moving, a driver indicated incident, etc.

In some embodiments, an insurer, or any remote party, may decide that they want to retrieve the image data with the overlaid vehicle data from computer memory. An insurer may receive a message that one of the vehicles that they provide insurance cover for has been involved in an accident, and they may decide that they want to analyse the data themselves. In such embodiments, the insurer can send a data retrieval message wirelessly to the vehicle, which instructs a computer processor on the vehicle to retrieve data corresponding to a specified time frame from computer memory and transmit that data back to the requestor. A third party can remotely interrogate data stored in computer memory. Preferably, a third party can retrieve the data without input from the vehicle owner/driver, and more preferably without the vehicle owner/driver even knowing about the data retrieval.

In other embodiments a crash sensor within the vehicle can retrieve and send data automatically to a third party, for example an insurer, when a crash has been sensed. The retrieved data may correspond to the last 30 minutes, as an example. Embodiments of the invention can enable an insurer to know the circumstances surrounding an accident, and subsequent insurance claim, even before the insurance claim has been submitted.

Feedback may be provided to the driver based upon the stored vehicle and image data. The feedback may comprise replaying the image data with the overlaid vehicle data to the driver on a visual display, preferably replaying portions of the image data that correspond to one or more incidents. The visual display may be a monitor connected to a personal computer, a laptop computer display, a television, a mobile telephone display, etc. In other embodiments, the feedback may comprise playing back audio portions of the footage to the driver.

In some embodiments, the feedback may comprise a report, preferably a statistical report, that provides analysis of the driver. The analysis may be performed automatically by a computer program, or the analysis may be performed manually by a person. The person who performs the analysis may be a driving instructor, an employer/manager of the driver, a law enforcement officer, or any other person.

In some embodiments, the feedback may be a comparison between the driver's old performance and the current performance. This can enable a driver's progress and learning to be monitored. The comparison between a drivers previous performance and current performance can enable the driver's insurance premiums to be increased or decreased depending on whether the driver's performance has increased or decreased.

FIG. 2 shows a schematic representation of the combination of vehicle data and image data according to an embodiment of the present invention. The combined data can be illustrated graphically on a screen 200 which consists of the image data 202 and the vehicle data 204 overlaid in the top left hand corner of the image 202. It will be appreciated that the vehicle data 204 could be positioned at any location within the image 202, and in some embodiments the vehicle data may be semitransparent such that a user can still see images behind the vehicle data 204.

In some embodiments, it may be possible for a user to select whether or not the vehicle data is shown in order for the image to be analysed more closely. It may also be possible for a user to control in which region of the image 202 the vehicle data is shown, and this can be useful if a particularly important part of the image 202 would otherwise be obscured by the vehicle data 204.

In this embodiment, the image data 202 is taken from an image recording mechanism, for example a video camera, pointing out of the side of the vehicle. The image 202 shows two other vehicles 206 that are travelling in an adjacent lane 208 to the vehicle in which the video camera is fitted. As discussed above, any number of video cameras may be fitted in or on the vehicle, and may point in any direction relative to the vehicle in which it is fitted.

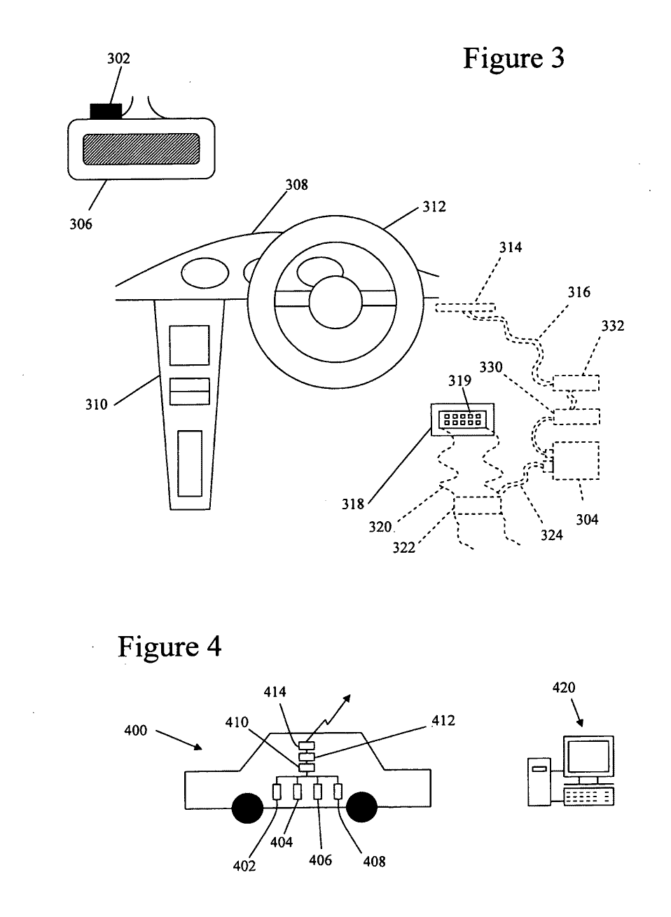

FIG. 3 shows a schematic view of the inside of a vehicle fitted with an image recording mechanism 302, vehicle data gathering mechanism 304, computer processor 330, computer memory 332, and a transceiver 314. Also shown in FIG. 3 are the steering wheel 312, the dashboard 308 and the central column 310.

In this embodiment, the image recording mechanism is a video camera 302 mounted facing forwards on a rear view mirror 306, the vehicle data gathering mechanism is an EOBD data recorder 304 that has been connected to an existing EOBD socket 322 in the vehicle, and the transceiver is an antenna 314. It will be appreciated, although it is not shown in the diagram, that the video camera 302 is in communication with the computer processor 330, either directly or indirectly, such that the data recorded by each of the devices 302, 304 can be combined by the computer processor 330 and stored in computer memory 332. The combined data can then be transmitted to an off-vehicle processor by antenna 314.

Mounting the video camera 302 on the rear view mirror provides the advantage that the recorded images can closely reflect what the driver is actually seeing. The rear view mirror will be at a similar height to the driver's eyes, and only offset a little from the left or the right of the driver, depending on whether the vehicle is left-hand or right-hand drive.

In this embodiment, the existing EOBD socket 322 has been withdrawn from its original mounting 318 in the vehicle interior, and has been allowed to drop back into a cavity behind the interior trim. A substitute cable 320 connects the existing EOBD socket to a substitute EODB socket 319 which is located within the mounting 318 in the vehicle interior such that the substitute EODB socket can continue to be used in the usual way as if it were the original EODB socket 322. In addition, a further cable 324 “taps-off” data from the original EOBD socket 322 and provides this “tapped-off” data to the EOBD data-monitoring device 304.

The EOBD data-monitoring device 304 is connected to a computer processor 330, which in turn is connected to a computer memory device 332. The computer processor 330 is arranged to process the vehicle data received from the EOBD data-monitoring device 304 and image data received from the video camera 302, and store processed and/or unprocessed vehicle and image data in computer memory 332. Processed data may be the combination of the vehicle data and the image data.

In this embodiment, the computer memory 332 is a solid state erasable re-writable memory. It may be fixed in the vehicle or it may be a portable memory device, for example a memory stick, memory card, or a similar memory device. Using a portable memory device can provide a convenient way to transfer data from the vehicle to an off-vehicle processor to perform further processing on the data if required, back-up the data, or simply to view the recorded image data with the vehicle data overlaid thereon. In some embodiments, the memory (e.g. memory stick) may be arranged to store about one months time of footage, after which time, the memory device may be replaced, or old data may be deleted. The amount of time that a memory can store may not include time when the vehicle is stationary or is not being used. The one months time worth of data that can be stored may comprise one month's time of on-the-road driving. The portable memory device may be 256 Megabytes, 512 Megabytes, 1 Gigabyte, 2 Gigabytes, 4 Gigabytes, 8 Gigabytes, or any other size. The portable memory device may be arranged to store 50 million frames of overlaid data, as an example.

The computer memory 332 is connected to the antenna 314 by cable 316. The antenna 314 is a transceiver, which is arranged to transmit the vehicle data from the data-monitoring device 304 to an off-vehicle processor.

In some embodiments, the antenna 314 may be arranged to receive instructions from an off-vehicle computer (not shown). For example, an operator of the off-vehicle computer may request that combined image and vehicle data relating to a certain time period is transmitted from the computer memory 332 in the vehicle to the off-vehicle computer. Information could be requested in relation to the last five minutes, for example or for any time period. An operator of the off-vehicle computer may require further information in relation to an automatically identified, or unidentified, incident. This can allow selective retrieval of data from in-vehicle computer memory 332.

It will be appreciated that the hardware components of the data monitoring devices 302, 304, computer processor 330, computer memory 332 and transceiver 314 may be connected together in any conventional way in order to perform the operations discussed above.

It will be appreciated that in other embodiments, the EOBD data monitoring device 304 and the video camera 302 may have their own independent computer processors, computer memories, and/or transceivers/antennas, and that the combining of the image data and vehicle data could be performed by an off-vehicle processor that is arranged to receive data from the independent transceivers/antennas.

FIG. 4 shows an alternative embodiment of apparatus for training a driver according to the present invention. The apparatus comprises a vehicle 400 having vehicle data gathering mechanism 402, image gathering mechanism 404, trip data gathering mechanism 406, and vehicle location data gathering mechanism 408. The four data gathering mechanism 402, 404, 406, 408 are all connected to a computer processor 410, which in turn is connected to a computer memory 412, and a transceiver 414.

The apparatus also comprises a personal computer 420, which is arranged to provide feedback to the driver of the vehicle. Personal computer 420 is one example of a feedback means/mechanism that can be used with embodiments of the present invention.

Examples of vehicle data gathering mechanism 402 and image data gathering mechanism 404 have been discussed above. In this embodiment, the apparatus also comprises trip data gathering mechanism 406 and vehicle location gathering mechanism 408.

The trip data gathering mechanism 406 is arranged to store data in relation to a single trip or journey. The journey may be started once a vehicle engine is turned on, and the journey may finish when the vehicle engine is turned off. In other embodiments, the driver may identify the start and end of a journey himself by pressing a button, or by identifying the start of a journey in any other way.

In some embodiments, a journey may not be terminated if the engine of the vehicle is turned off for only a short time, for example if the engine is stalled or if the engine is turned off temporarily, for example whilst the vehicle is refueled.

The trip data may include, but is not limited to: the current date, the current time, the trip start time, the trip duration, the distance traveled on the trip, the identity of the driver for the trip, an odometer reading at the start of the trip, a fuel level in the vehicle at the start of the trip, and fuel used during the trip.

A trip may be the same as a journey as discussed above.

The vehicle location data gathering mechanism 408 may be any conventional device, for example a Global Positioning System (GPS).

The vehicle location data may include, but is not limited to: latitude of the vehicle, longitude of the vehicle, altitude of the vehicle, and orientation of the vehicle.

One, some, or all of the data gathered by the data gathering mechanism 402, 404, 406, 408 may be processed by computer processor 410, stored in computer memory 412, and transmitted by transceiver 414. Also, one, some, or all of the data gathered by the data gathering mechanism 402, 404, 406, 408 may be compared to one or more rules to determine whether or not an incident has occurred.

The personal computer 420 is connected to the Internet. The driver of the vehicle can log into a personal account through a website on the Internet in order to pick up any feedback that has been provided for that driver. Examples of feedback are discussed above.

In some embodiments, the driver may receive some sort of indicator that there is feedback available for the driver, and examples of such an indicator can include an email, an SMS text message to their mobile telephone, a letter through the post, etc.

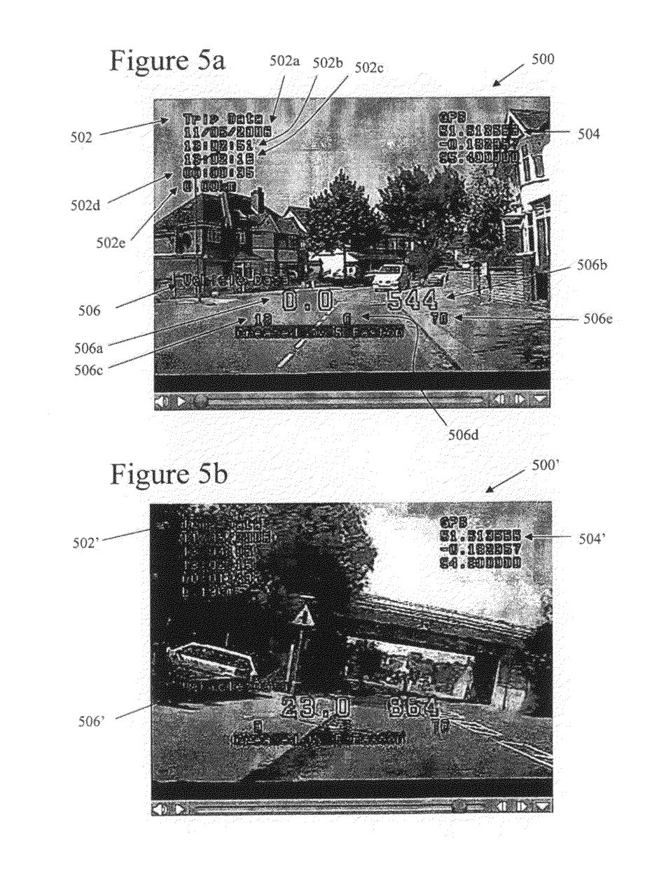

FIG. 5a shows a still image from video footage having data overlaid thereon, and comprises the image 500 with vehicle data 506, trip data 502 and vehicle location data 504 overlaid thereon. FIG. 5a shows a still image that has been taken towards the start of a journey, whilst the vehicle is stationary.

In this embodiment, the vehicle data 506 comprises the vehicle speed 506a, the engine rpm 506b, and other parameters 506c, 506d, and 506e which relate to vehicle data.

Also shown below the vehicle data is the name of the person who created the combination of image data and vehicle data. In some embodiments, this may be the driver, and in other embodiments it may be the name of a manager or supervisor of the driver. The combination may of course be done automatically by a computer processor.

The trip data 502 is shown in the top left hand corner of FIG. 5a. The trip data includes the date 502a, the current time 502b, the journey start time 502c, the journey duration 502d, and the distance traveled 502e in the journey.

Global Positioning System (GPS) information is shown in the top right hand corner of FIG. 5a. The GPS data identifies the physical location of the vehicle and is known in the art.

It can be seen from FIG. 5a, that the vehicle in question is stationary, and that the engine is ticking over at 544 rpm. The trip data 402 indicates that the journey started thirty five seconds ago, and that the vehicle has not yet moved.

FIG. 5b shows a still image from the combined video footage and vehicle data later on in the same journey to that shown in FIG. 5a. At the instant of the still image shown in FIG. 5b, the vehicle has traveled 0.19 kilometres and is one minute and forty nine seconds into the journey, as indicated by trip data 502′. It can also be seen from the vehicle data 506′, that the vehicle is travelling at 23 mph and that the engine is turning over at 864 rpm.

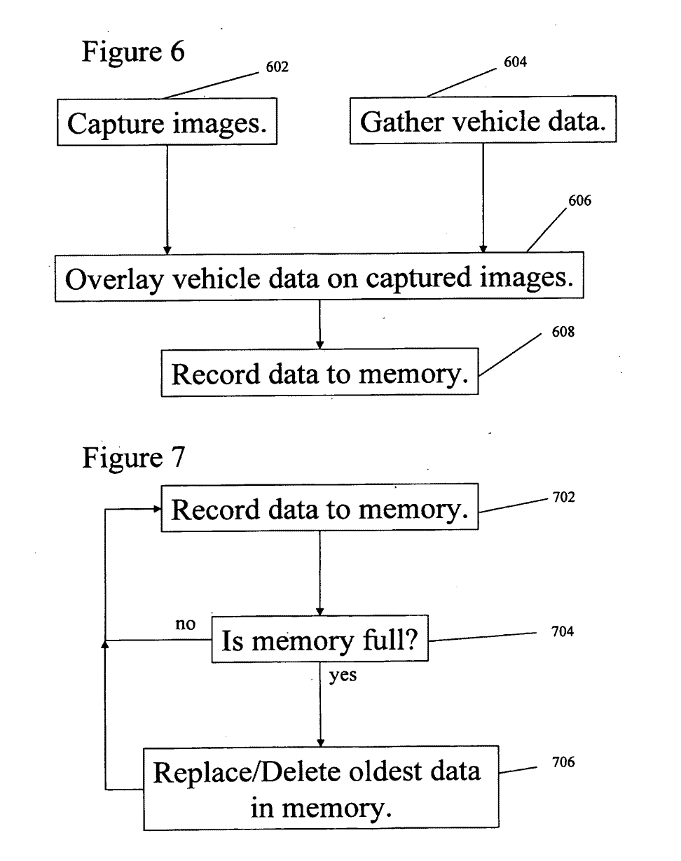

FIG. 6 shows a flow chart showing the steps performed according to a method of overlaying vehicle data on captured images of embodiments of the present invention. Images are captured at step 602 by an image recording mechanism, for example a video camera associated with the vehicle.

At step 604, vehicle data relating to parameters of the vehicle are gathered. It will be appreciated that steps 602 and 604 are performed concurrently, or at least for overlapping periods of time, such that vehicle data is gathered at the same time as images are captured.

The vehicle data is overlaid on the captured images at step 606 such that the overlaid vehicle data is cotemporaneous with the image on which it is overlaid. The combined image and vehicle data is then stored to computer memory at step 608. The recorded data can then be used to train a driver as discussed above.

FIG. 7 shows a flow chart showing the steps performed by a method of recording the combined data to memory of embodiments of the present invention.

Combined image and vehicle data is recorded to computer memory at step 702. The computer memory may be located on the vehicle, off the vehicle, or may be split between a computer memory on the vehicle and off the vehicle. In some embodiments, data may only be recorded during a journey, and this can reduce the possibility that the computer memory is wasted by storing data when the vehicle is not being used.

At step 704, a check is made as to whether or not the computer memory is full. If the computer memory is not full, the method returns to step 702 and continues to record data to the computer memory. If it is determined that the computer memory is full at step 704, or is nearly full, for example 90% full, or any other percentage full, a portion of the oldest data is overwritten or deleted from computer memory at step 706 and the method returns to step 702 in order to record more data. Preferably, the computer memory is a first-in-first-out (FIFO) memory.

In some embodiments, certain data may be identified such that it should not be deleted from computer memory, even when it is the oldest data in computer memory. In this case the oldest data that has not been identified as not to be deleted from memory, is deleted. Examples of such data may be data that is in relation to an incident, or data that a user has flagged as being important for any other reason. In this case, the identified data can be kept in computer memory until a user makes the conscious decision to delete that data, which may involve removing the identifier that the data should not be deleted, or may involve the user actually deleting the data themselves. For example, once an incident has been analysed, the data may be moved to a more permanent computer memory location in an off-vehicle computer, and the identifier that the data should not be deleted from vehicle memory can be removed.

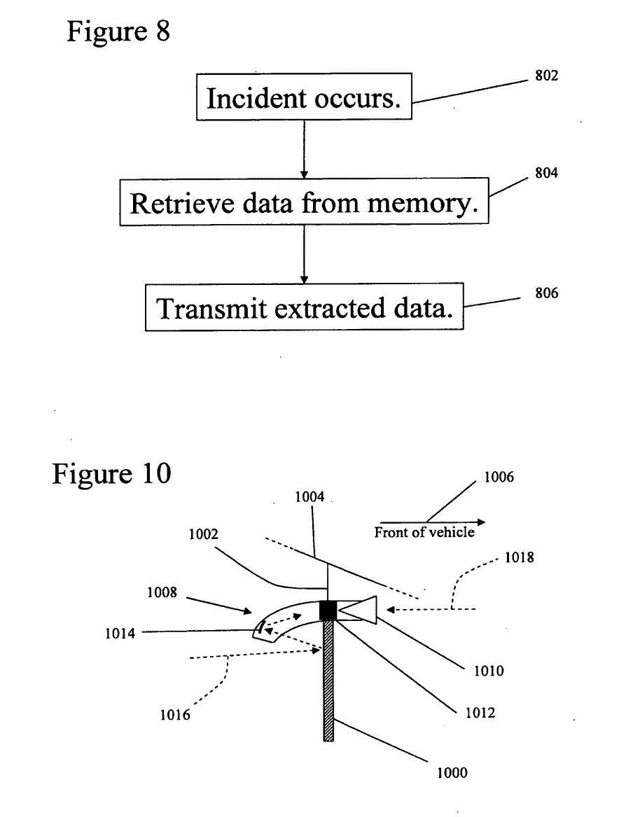

FIG. 8 shows a flow chart showing the steps performed according to embodiments of a method of the present invention for transmitting extracted data in relation to an incident. At step 802, an incident occurs. Preferably, an incident is identified by monitoring variations in the vehicle data, and/or the trip data, and/or the vehicle location data, and/or the image data, and comparing this data with a set of rules as discussed above.

At step 804, following the occurrence of an incident, the combined image and vehicle data is retrieved/extracted from computer memory. The retrieved data is preferably selected to fully cover the period of time during which the incident occurs. This may involve retrieving data for a predefined period of time before the incident was triggered, and in some embodiments also for a predefined period of time after the incident was triggered or after the incident finishes. The retrieved data is then transmitted from the vehicle at step 806.

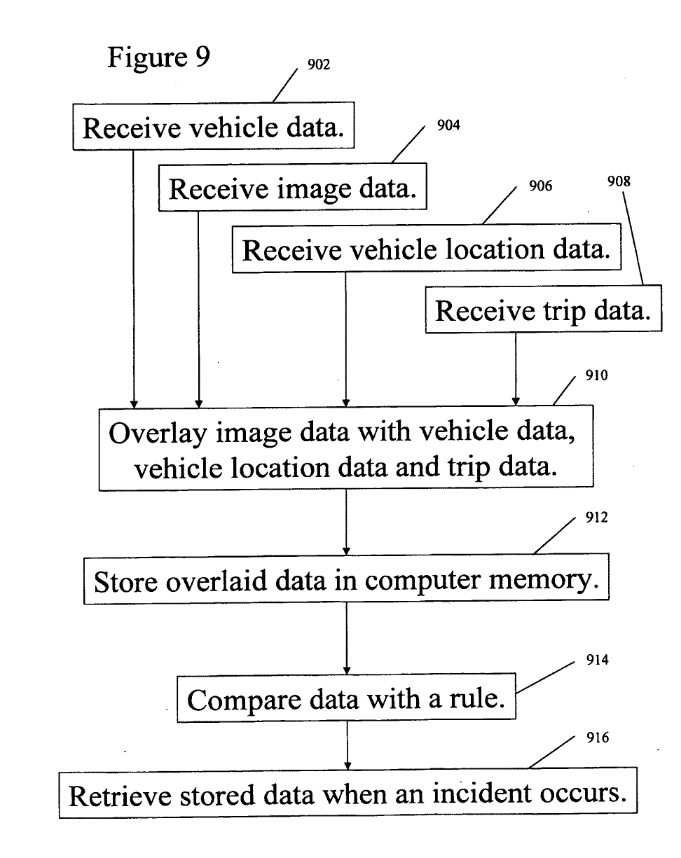

FIG. 9 shows a flow chart showing the steps performed according to a method of retrieving stored data from memory when an incident occurs. Vehicle data, image data, vehicle location data and trip data are received at steps 902, 904, 906 and 908 respectively.

At step 910, the received image data is overlaid with the cotemporaneous vehicle data, vehicle location data and trip data, and the overlaid data is stored in computer memory at step 912.

Any one of the image data, vehicle data, vehicle location data and trip data may be compared with at least one rule at step 914, either independently or in combination with any of the other data. If any of the data does not satisfy a rule at step 914, an incident is identified and the method moves on to step 916 where the overlaid data that has been stored in memory at step 912 in relation to the identified incident is retrieved.

FIG. 10 shows an example of an image data gathering mechanism 1008 according to an embodiment of the present invention. The image data gathering mechanism is a digital video camera mounted on a rear view mirror 1000 within a vehicle. As is known in the art, the rear view mirror 1000 is mounted to a front windscreen 1004 by a mounting bracket/stem 1002. The direction of the front of the vehicle is indicated by arrow 1006.

The video camera 1008 is mounted on top of the rear view mirror 1000, although the video camera 1008 may be mounted at any location on the rear view mirror 1000. The video camera 1008 may be clipped, glued, or attached to the rear view mirror 1000 by any conventional mechanism. The video camera comprises a lens 1010 facing forwards in the vehicle that is arranged to collect light 1018 that comes from in front of the vehicle. Lens 1010 collects images from the front of the vehicle and focuses them onto a front surface of light receiving mechanism 1012, which is arranged to convert the light signals into electronic signals that can be stored to represent the images in front of the vehicle.

In addition to the forward facing lens 1010, the video camera is also arranged to receive light 1016 from behind the vehicle. Light that is received from behind the vehicle is reflected by the rear view mirror 1000, and on to an internal mirror 1014. The internal mirror 1014 is arranged to reflect the light that is received from behind the vehicle onto a back surface of the light receiving mechanism 1012, which is again arranged to convert the light signals into electronic signals that can be stored to represent the images behind the vehicle. The video camera 1008 is arranged to capture substantially what a driver of the vehicle sees in front of them and also what the driver sees in their rear view mirror.

In some embodiments, some, or all, of the casing of the video camera 1008 may be transparent in order to allow light from behind the vehicle to pass through the casing before being reflected by the rear view mirror 1000 and/or the internal mirror 1014. Having a transparent casing can also minimise how much of the rear view mirror 1000 is obscured by the video camera 1008. Preferably the internal mirror 1014 is curved in order to collect and focus the light that has been reflected by the rear view mirror 1000.

The video camera 1008 is a single device that is arranged to record images from both in front of, and behind, a vehicle.

In some embodiments, the present invention may be used as an evidence gatherer when vehicles are parked in car parks. It is known that minor accidents can occur in car parks, which can leave vehicles dented and/or scratched. A vehicle may be accidentally driven into another vehicle in a neighbouring car parking space when a driver is manoeuvring their vehicle in the confined spaces of a car park. Also, people opening doors of neighbouring vehicles may dent another vehicle if they do not open their doors carefully.

Embodiments of the invention can be used as an evidence gatherer in order to record which vehicles are parked to either side of the vehicle, and therefore identify a suspect if a dent, scratch, or other damage, occurs to the vehicle while the vehicle has been left stationary in the car park. The vehicle registration plates of vehicles may be recorded by the video camera when the vehicle approaches a car parking space. If a dent subsequently occurs on the left-hand side of the vehicle, the registration number of the vehicle on the left of the vehicle can be retrieved, and further investigation can be performed to determine if it was that vehicle that caused the dent.

In some embodiments, the video camera may be left running whilst the vehicle is left in the car park in order to continue to gather evidence of the vehicle registration numbers of vehicle that park in neighbouring spaces/bays.

The driver of the vehicle may identify to an electronic system in the vehicle that they are in a car park, and therefore that forward and/or rearward facing video cameras should be left running. The driver may identify this to the system in any known way, for example by pressing a button on a user interface. In other embodiments, the video camera/s may be left running automatically for a predetermined period of time every time the vehicle stops, for example for one hour after the vehicle stops.

In some embodiments, the video camera may be able to detect when the vehicle is actually hit or damaged, for example if the damage causes the vehicle to move this may be picked up by a motion sensor or by the video camera.

The evidence in relation to damage caused by neighbouring vehicles may be used as part of an insurance claim, and/or may be used in criminal proceedings in relation to vehicle damage.

It will be appreciated that any of the features of any of the embodiments of the invention, may also be used with other embodiments of the invention.

1. A method for training a driver, the method comprising the steps of:
receiving vehicle data from a vehicle data gathering mechanism associated with the vehicle;
receiving image data from an image data gathering mechanism associated with the vehicle;
overlaying the image data with cotemporaneous vehicle data; and
storing the image data with the overlaid vehicle data in computer memory.

2. The method of claim 1, further comprising:
providing feedback to the driver by replaying the image data with the overlaid vehicle data to the driver.

3.-30. (canceled)

31. The method of claim 1, further comprising comparing one, or both, of the image data and vehicle data with a rule to determine if an incident has occurred.

32. The method of claim 1, further comprising:
receiving vehicle location data from a vehicle location data gathering mechanism; and
overlaying the image data with cotemporaneous vehicle location data.

33. The method of claim 1, further comprising:
receiving trip data from a trip data gathering mechanism; and
overlaying the image data with cotemporaneous trip data.

34. The method of claim 1, wherein the vehicle data is received from an engine management system within the vehicle.

35. The method of claim 34, wherein the vehicle data is received from an On Board Diagnostics (OBD) connector within the vehicle.

36. The method according to claim 1, further comprising:
deleting or overwriting existing image data with overlaid data in computer memory and storing new image data with overlaid data to memory which previously held earlier existing image data with overlaid data.

37. The method of claim 36, wherein portions of the existing image data with overlaid data in computer memory are identified as not to be deleted from computer memory.

38. The method of claim 37, wherein the portions of the existing image data with overlaid data in computer memory that are identified as not to be deleted from computer memory are associated with an incident.

39. An apparatus for training a driver, the apparatus comprising:
vehicle data gathering mechanism arranged to provide vehicle data associated with a vehicle;
image data gathering mechanism arranged to provide image data associated with the vehicle;
a computer processor arranged to overlay the image data with cotemporaneous vehicle data; and
a computer memory arranged to store the image data with the overlaid vehicle data.

40. The apparatus of claim 39, further comprising a visual display arranged to replay the image data with the overlaid vehicle data to the driver.

41. The apparatus of claim 39, wherein the computer processor is arranged to compare one, or both, of the image data and vehicle data with a rule to determine if an incident has occurred.

42. The apparatus of claim 39, further comprising:
vehicle location data gathering mechanism arranged to provide vehicle location data associated with the vehicle; and
wherein the computer processor is further arranged to overlay the image data with cotemporaneous vehicle location data.

43. The apparatus of claim 39, further comprising:
trip data gathering mechanism arranged to provide trip data associated with the vehicle; and
wherein the computer processor is further arranged to overlay the image data with cotemporaneous trip data.

44. The apparatus of claim 39, wherein the vehicle data gathering mechanism is arranged to receive the vehicle data from an engine management system within the vehicle.

45. The apparatus of claim 44, wherein the vehicle data gathering mechanism is arranged to receive vehicle data from an On Board Diagnostics (OBD) connector within the vehicle.

46. The apparatus according to claim 39, wherein the computer processor is further arranged to delete or overwrite existing image data with overlaid data from computer memory and store new image data with overlaid vehicle data to memory which previously held earlier existing image data.

47. The apparatus of claim 46, wherein the computer processor is arranged to identify portions of the existing image data with overlaid data in computer memory as not to be deleted from computer memory.

48. The apparatus of claim 47, wherein the computer processor is arranged to identify portions of the existing image data with overlaid data in computer memory as not to be deleted from computer memory, that are associated with an incident.
